(19) United States
(12) Patent Application Publication
(10) Pub. No.: US 2026/0023484 A1
(43) Pub. Date: Jan. 22, 2026

(54) SYSTEM AND METHOD FOR RAID GROUP MIRRORING

(71) Applicant: Microchip Technology Inc., Chandler, AZ (US)

(72) Inventor: Iyyappan R., Bangalore (IN)

(73) Assignee: Microchip Technology Inc., Chandler, AZ (US)

(21) Appl. No.: 18/902,738

(22) Filed: Sep. 30, 2024

(30) Foreign Application Priority Data
Jul. 17, 2024 (IN) 202441054567

(51) Int. Cl. G06F 3/06

(52) U.S. Cl. CPC G06F 3/0619; G06F 3/0632; G06F 3/0689

(57) ABSTRACT

Systems for redundant array of independent disk (RAID) group mirroring may include a client computing device and a data storage system. The data storage system may include a first disk array, a second disk array, a virtual disk, at least one processor, and a memory. The memory may store instructions that, when executed by the at least one processor, cause the at least one processor to: assign the virtual disk to the client computing device, assign the first disk array as a primary disk group of the virtual disk, assign the second disk array as a secondary disk group of the virtual disk, receive data from the client computing device, write the data to the first and second disk arrays, detect a failure of the first disk array, and based on the detected failure, assign the second disk array as the primary disk group.

### CROSS-REFERENCE TO RELATED APPLICATIONS

The current patent application claims the benefit under 35 U.S.C. § 119 (a) of the priority date of Indian Provisional Application No. 202441054567 titled “SYSTEM AND METHOD FOR RAID GROUP MIRRORING”; and filed Jul. 17, 2024. The Provisional application is hereby incorporated by reference, in its entirety, into the current patent application.

### TECHNICAL FIELD

Various examples of the present disclosure relate to systems and methods for redundant array of independent disk (RAID) group mirroring.

### BACKGROUND

Data storage systems may utilize redundant array of independent disks (RAID) groups. RAID groups may have associated RAID levels. Each RAID level may have a fault tolerance of one or more disks, such that data may be retained when one or more disks fail. However, if each disk in a RAID group fails, the data may not be retained.

This background discussion is intended to provide information related to the present disclosure which is not necessarily prior art.

### SUMMARY OF THE INVENTION

According to various examples of the present disclosure, a system may be provided. The system may include a client computing device and a data storage system. The data storage system may include a first disk array, a second disk array, a virtual disk, at least one processor, and a memory. The memory may store instructions that, when executed by the at least one processor, cause the at least one processor to perform the following operations: assign the virtual disk to the client computing device; assign the first disk array as a primary disk group of the virtual disk; assign the second disk array as a secondary disk group of the virtual disk; receive, by the virtual disk, data from the client computing device; write, by the virtual disk, the data to the first disk array and the second disk array; detect a failure of the first disk array; and, based on the detected failure, assign the second disk array as the primary disk group.

According to various examples of the present disclosure, a computer implemented method is provided. A virtual disk may be assigned to a client computing device. A first disk array may be assigned as a primary disk group of the virtual disk. A second disk array may be assigned as a secondary disk group of the virtual disk. The virtual disk may receive data from the client computing device. The virtual disk may write the data to the first disk array and the second disk array. A failure of the first disk array may be detected. Based on the detected failure, the second disk array may be assigned as the primary disk group.

According to various examples of the present disclosure, non-transitory computer readable media may be provided. The non-transitory computer readable media may include instructions stored thereon that, when executed by at least one processor, cause the at least one processor to perform the following operations: receive data from a client computing device; write the data to a first disk array and a second disk array, said first and second disk arrays being managed by a virtual disk assigned to the client computing device, said first disk array being a primary disk group assigned to the client computing device, said second disk array being a secondary disk group assigned to the client computing device; detect a failure of the first disk array; and based on the detected failure, assign the second disk array as the primary disk group.

### BRIEF DESCRIPTION OF THE DRAWINGS

FIG. 1 illustrates an example environment of a system for redundant array of independent disk (RAID) group mirroring;

FIG. 2 illustrates the system of the environment FIG. 1;

FIG. 3 illustrates an example client computing device of the system of FIG. 1;

FIG. 4 illustrates an example server of the data storage system of FIG. 1; and

FIG. 5 illustrates an example method for RAID group mirroring.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

Various examples of the present disclosure relate to systems and methods for redundant array of independent disk (RAID) group mirroring. An example system of the present disclosure may include a data storage system, a client computing device, and a communication network. The data storage system may include a server and a plurality of physical disks. The server may include a controller for configuring the plurality of physical disks. The controller may assign a virtual disk of the data storage system to the client computing device. The virtual disk may be associated with the plurality of physical disks. The physical disks may include a first disk array and a second disk array. The first disk array may be a first subset of the physical disks. The second disk array may be a second subset of the physical disks. The first subset of physical disks may be different than the second set of physical disks. In various examples, the first and second disk arrays may be located in a same geographic location, such as a data center. The controller may assign the first disk array as a primary disk group of the virtual disk. The controller may assign the second disk array as a secondary disk group of the virtual disk. In various examples, the primary disk group and the secondary disk group may be configured to have a same RAID configuration. The primary and secondary disk groups may include an equal number of physical disks. In various examples, the following RAID configuration features are held in common between the primary and secondary disk groups: RAID level, number of disks, disk size and/or capacity, drive type, memory management programs and/or logic, and the like.

In various examples, the RAID level may include RAID 0, RAID 1, RAID 5, RAID 6, RAID 1+0 RAID 5+0, and RAID 6+0, without limitation. The RAID level may be selected by a user of the client computing device during registration. The RAID 0 level may include two (2) physical disks in the primary disk group and two (2) physical disks in the secondary disk group. The RAID 1 level may include two (2) physical disks in the primary disk group and two (2) physical disks in the secondary disk group. The RAID 5 level may include three (3) physical disks in the primary disk group and three (3) physical disks in the secondary disk group. The RAID 6 level may include four (4) physical disks in the primary disk group and four (4) physical disks in the secondary disk group. The RAID 1+0 level may include four (4) physical disks in the primary disk group and four (4) physical disks in the secondary disk group. The RAID 5+0 level may include six (6) physical disks in the primary disk group and six (6) physical disks in the secondary disk group. The RAID 6+0 level may include eight (8) physical disks in the primary disk group and eight (8) physical disks in the secondary disk group. It would be appreciated by one of ordinary skill in the art that other RAID levels may be used and the number of physical disks in each RAID group may constitute a minimum number of disks needed for each RAID level.

The client computing device may access the first and second disk arrays through the virtual disk. The client computing device may send data to the virtual disk, through the communication network, to be stored on the first and second disk arrays. The virtual disk may write the data to the first and second disk arrays. The data written to the first and second disk groups may be identical such that the second disk group may mirror the first disk group. In various examples, the virtual disk may write the data to the first and second disk arrays simultaneously or contemporaneously.

The virtual disk may detect a failure of the first disk group. The failure may be detected in at least one disk of the first disk group. In various examples, the failure may be detected in each disk of the first disk group. In response to detecting the failure, the second disk group may be assigned as the primary disk group. The client computing device may continue to access the data in the second disk group through the virtual disk.

After the secondary disk array is assigned as the primary disk group, the first disk array may be rebuilt. Rebuilding the first disk array may include removing or replacing faulty physical disks in the first disk array. In various examples, rebuilding the first disk array may include assigning a third subset of physical disks as the first disk array and the secondary disk group. In various examples, rebuilding the first disk array may include replacing or repairing one or more faulty disks. In other examples, rebuilding the first disk array may include assigning a third subset of the physical disks to the first disk array to replace the first subset of disks and serve as the secondary disk group. After the first disk array is rebuilt, the first disk array may be assigned as the secondary disk group.

In various examples, the controller may copy the data from the second disk array into the first disk array in connection with rebuilding the first disk array. After assigning the first disk array as the secondary disk group, additional data received from the client computing device may be written to the first disk array and the second disk array. The additional data may be written to the first and second disk arrays simultaneously or contemporaneously. If a failure is detected in the second disk array, the first disk array may be assigned as the primary disk group. Accordingly, the data storage system may have a robust fault tolerance that can withstand catastrophic failure of an entire disk group without losing any data.

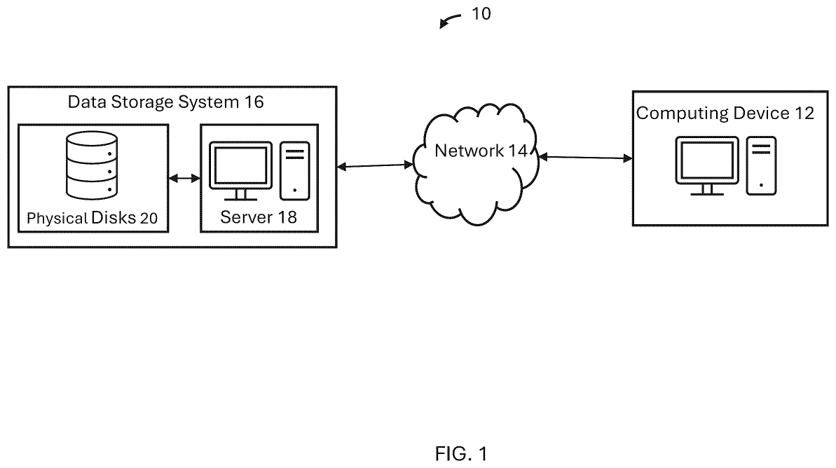

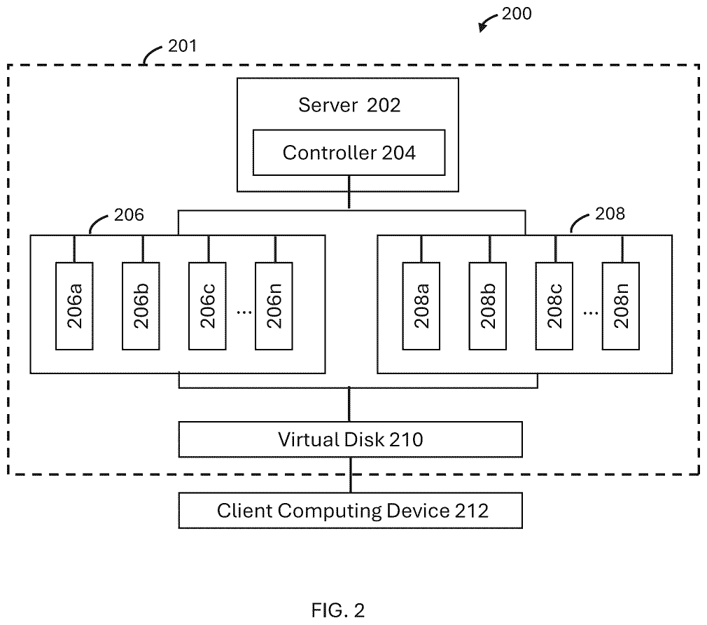

FIG. 1 illustrates an environmental view of an example system 10 for RAID group mirroring. The system 10 may include a client computing device 12, a communication network 14, and a data storage system 16. The data storage system 16 may include a server 18 and a plurality of physical disks 20. The server 18 may configure the physical disks 20 into various RAID groups having various RAID levels. In various examples, the client computing device 12 may register with the server 18 over the communication network 14 to store data in a set of the physical disks 20. A user of the client computing device 12 may select a particular RAID configuration for the subset of physical disks. In various examples, the RAID configuration may include a pair of mirrored RAID groups having an equal number of disks in each group. After registration, the client computing device 12 may send data over the communication network 14 to the server 18. In various examples, the server 18 may include a controller (e.g. the controller 204 discussed with reference to FIG. 2) to facilitate writing the data to the pair of mirrored RAID groups. The data received from the client computing device 12 may simultaneously or contemporaneously be written to the physical disks 20 of each mirrored RAID group.

In various examples, the pair of mirrored RAID groups may include a first disk array and a second disk array. The first disk array and the second disk array may be accessed by the client computing device 12 through a virtual disk assigned to the client computing device 12. The controller of the server 18 may assign the virtual disk to the client computing device. The first disk array may be a first subset of the physical disks 20. The second disk array may be a second subset of the physical disks 20. The first and second disk arrays may have a same number of physical disks 20. The controller of the server 18 may assign the first disk array to be a primary disk group of the virtual disk. The primary disk group may be accessed by the virtual disk to perform read operations to retrieve data requested by the client computing device 12. In various examples, the primary disk group may be accessed by the client computing device 12 through the virtual disk. The server 18 may assign the second disk array to be a secondary disk group of the virtual disk. In various examples, the controller of the server 18 may detect a failure in the primary disk group. Upon detecting the failure, the second disk array may be assigned to be the primary disk group. Following reassignment of the second disk array, the first disk array may be rebuilt. After the first disk array is rebuilt, the controller of the server 18 may assign the first disk array to be the secondary disk group.

The communication network 14 may be partly or entirely internal to an organization or group of affiliated entities, for example where the server 18 manages databases of and/or provides cloud-based services to and under the management of an organization whose users utilize client computing device 12. Also or alternatively, the client computing device 12 may access the server 18 via transmissions, at least in part, across public/semi-public telecommunication network infrastructure, with the communication network 14 being at least in part comprised of such public/semi-public telecommunication network infrastructure.

All or some of the client computing device 12 and server 18, and/or all or some of the virtual resources managed thereby, may at least partly comprise a secure network computing environment. Alternatively or in addition, the client computing device 12 and server 18 may manage access therebetween under an authentication management framework.

In one or more embodiments, the client computing device 12 may comprise desktops, laptops, cellular telephones (e.g., smartphones), smart watches or other electronic wearable apparel, tablets, implanted smart devices, or any other electronic device or other computing devices. In one or more embodiments, the server 18 may comprise cloud server, domain controllers, application servers, database servers, database web servers, file servers, mail servers, catalog servers or the like, or combinations thereof. However, it should be appreciated that the types of computing devices attributed to either client computing device 12 or server 18 may be interchangeable and are not limiting. More particularly, a client computing device 12 may be a server, and a personal computing device may be substituted to perform functions of a server 18, it being understood that the form of hardware chosen for each such computing device may vary according to the demands of particular embodiments without departing from the spirit of the present invention.

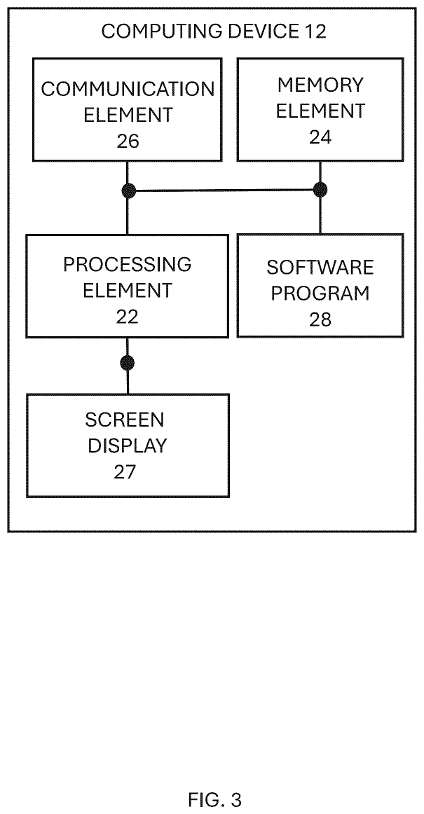

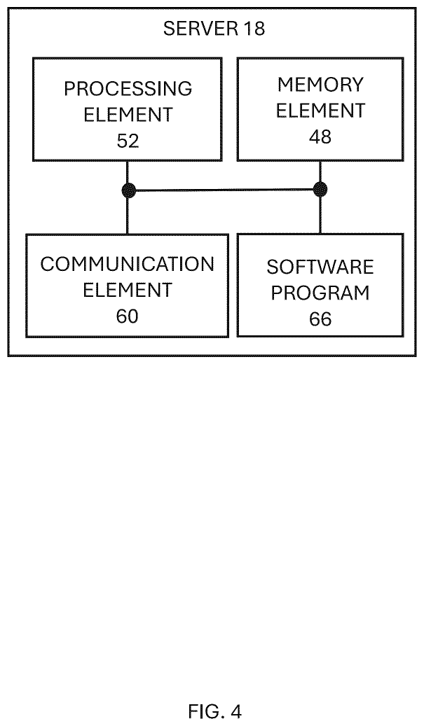

FIGS. 3 and 4 illustrate an example client computing device 12 and example server 18, respectively. Client computing device 12 may include a processing element 22, a memory element 24, and circuitry capable of wired and/or wireless communication with the communication network 14, including, for example, a transceiver or communication element 26. The client computing device 12 may additionally include a screen display 27, which may comprise a user interface of the client computing device 12. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen.

Further, each of the client computing device 12 and the server 18 may include a software application or program 28, 66 configured with instructions for performing and/or enabling performance of at least some of the steps set forth herein. In an embodiment, the software programs 28, 66 each comprises instructions stored on computer-readable media of memory elements 24, 48.

Generally, the server 18 may include a memory element 48, a processing element 52, a communication element 60, and a software program 66. The server 18 generally receives requests and queries for data and/or data storage and provision of services and resources from the client computing device 12, and exposes or otherwise provides such data, storage services, and other services and resources. The server 18 may assign the virtual disk to the client computing device 12, receive data from the client computing device 12 over the communication network 14, and send data to the client computing device 12 over the communication network 14.

The communication network 14 generally allows communication between the client computing device 12 and the server 18, for example in conjunction with configuring the virtual disk, primary disk group, and secondary disk groups, in addition to transmitting data to be stored in and retrieved from the virtual disk.

The communication network 14 may include the Internet, cellular communication networks, local area networks, metro area networks, wide area networks, cloud networks, plain old telephone service (POTS) networks, and the like, or combinations thereof. The communication network 14 may be wired, wireless, or combinations thereof and may include components such as modems, gateways, switches, routers, hubs, access points, repeaters, towers, and the like. The client computing device 12 and/or server 18 may, for example, connect to the communication network 14 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication elements 26, 60 generally allow communication between the client computing device 12, the server 18, and/or the communication network 14. The communication elements 26, 60 may include signal or data transmitting and receiving circuits, such as antennas, amplifiers, filters, mixers, oscillators, digital signal processors (DSPs), and the like. The communication elements 26, 60 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication elements 26, 60 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 26, 60 may establish communication through connectors or couplers that receive metal conductor wires or cables, like Cat 6 or coax cable, which are compatible with networking technologies such as ethernet. In certain embodiments, the communication elements 26, 60 may also couple with optical fiber cables. The communication elements 26, 60 may respectively be in communication with the processing elements 22, 52 and/or the memory elements 24, 48.

The memory elements 24, 48 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 24, 48 may be embedded in, or packaged in the same package as, the processing elements 22, 52. The memory elements 24, 48 may include, or may constitute, a “computer-readable medium.” The memory elements 24, 48 may store the instructions, code, code segments, software, firmware, programs, applications, apps, services, daemons, or the like that are executed by the processing elements 22, 52. In an embodiment, the memory elements 24, 48 respectively store the software applications/program 28, 60. The memory elements 24, 48 may also store settings, data, documents, sound files, photographs, movies, images, databases, and the like.

The processing elements 22, 52 may include electronic hardware components such as processors. The processing elements 22, 52 may include digital processing unit(s). The processing elements 22, 52 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 22, 52 may generally execute, process, or run instructions, code, code segments, software, firmware, programs, applications, apps, processes, services, daemons, or the like. For instance, the processing elements 22, 52 may respectively execute the software applications/programs 28, 60. The processing elements 22, 52 may also include hardware components such as finite-state machines, sequential and combinational logic, and other electronic circuits that can perform the functions necessary for the operation of the current disclosure. The processing elements 22, 52 may be in communication with the other electronic components through serial or parallel links that include universal busses, address busses, data busses, control lines, and the like.

Data sources hosted by any of the computing devices of the environment 10 may utilize a variety of formats and structures within the scope of the disclosure. For instance, relational databases and/or object-oriented databases may embody the data sources, and may be exposed for queries by one or more corresponding application programming interfaces (APIs). One of ordinary skill will appreciate that—while examples presented herein may discuss specific types of operating systems and/or databases-a wide variety may be used alone or in combination within the scope of the present disclosure.

Through hardware, software, firmware, or various combinations thereof, the processing elements 22, 52 may—alone or in combination with other processing elements—be configured to perform the operations of embodiments of the present disclosure. Specific examples of the technology will now be described in connection with the attached drawing figures. The embodiments are intended to describe aspects of the disclosure in sufficient detail to enable those skilled in the art to practice the disclosure. Other embodiments can be utilized and changes can be made without departing from the scope of the present disclosure. The system may include additional, less, or alternate functionality and/or device(s), including those discussed elsewhere herein. The following detailed description is, therefore, not to be taken in a limiting sense. The scope of the present disclosure is defined only by the appended claims, along with the full scope of equivalents to which such claims are entitled, unless otherwise expressly stated and/or readily apparent to those skilled in the art from the description.

Referring back to FIG. 1, the primary and secondary disk groups may correspond to the pair of mirrored RAID groups and may have a designated RAID level. Each mirrored RAID group may have a same RAID level. In various examples, the RAID level may include RAID 0, RAID 1, RAID 5, RAID 6, RAID 1+0 RAID 5+0, and RAID 6+0, without limitation. The RAID level may be selected by the client computing device 12 during registration. The RAID 0 level may include two (2) physical disks 20 in the primary disk group and two (2) physical disks 20 in the secondary disk group. The RAID 1 level may include two (2) physical disks 20 in the primary disk group and two (2) physical disks 20 in the secondary disk group. The RAID 5 level may include three (3) physical disks 20 in the primary disk group and three (3) physical disks 20 in the secondary disk group. The RAID 6 level may include four (4) physical disks 20 in the primary disk group and four (4) physical disks 20 in the secondary disk group. The RAID 1+0 level may include four (4) physical disks 20 in the primary disk group and four (4) physical disks 20 in the secondary disk group. The RAID 5+0 level may include six (6) physical disks 20 in the primary disk group and six (6) physical disks 20 in the secondary disk group. The RAID 6+0 level may include eight (8) physical disks 20 in the primary disk group and eight (8) physical disks 20 in the secondary disk group. It would be appreciated by one of ordinary skill in the art that other RAID levels may be used and the number of physical disks 20 in each RAID group may constitute a minimum number of disks needed for each RAID level.

In various examples, the controller of the server 18 may detect a failure of one or more of the physical disks 20 in the first disk array. In some examples, the controller of the server 18 may detect a failure of each of the physical disks 20 in the first disk array. Upon detecting the failure, the controller of the server 18 may assign the second disk array to be the primary disk group of the virtual disk. The client computing device 12 may continue to access the data written to the second disk array after the failure is detected in the first disk array. The client computing device 12 may continue to send data over the communication network to be written to the second disk array after the failure is detected in the first disk array. Accordingly, the client computing device 12 may have continuous access to the data stored in the secondary disk group. All data stored in the first and second disk arrays may be retained following the failure of the first disk array as a result of the data being written simultaneously or contemporaneously to the first and second disk arrays.

After the second disk array is assigned to be the primary disk group of the virtual disk, the first disk array may be rebuilt. After the first disk array is rebuilt, the first disk array may be assigned to be the secondary disk group of the virtual disk. After assigning the first disk array as the secondary disk group, additional data received from the client computing device 12 may be written to the first disk array and the second disk array. The additional data may be written to the first and second disk arrays simultaneously or contemporaneously. If a failure is detected in the second disk array, the first disk array may be assigned as the primary disk group. In various examples, no data may be lost due to a failure of each physical disk 20 in the first disk array. For the RAID 1, RAID 5, RAID 6, RAID 1+0 RAID 5+0, and RAID 6+0 levels, no data may be lost due to failure in one or more physical disks 20 in the secondary disk group, in addition to a failure of all physical disks 20 in the primary disk group. Accordingly, the data storage system 16 may have a robust fault tolerance that can withstand catastrophic failure of an entire disk group without losing any data.

FIG. 2 illustrates an example system 200 for RAID group mirroring. The system may include a data storage system 201 and a client computing device 212. The data storage system 201 may correspond to the data storage system 16 of FIG. 1. The client computing device 212 may correspond to the client computing device 12 of FIG. 1. The data storage system 201 may include a server 202, a first disk array 206, a second disk array 208, and a virtual disk 210. The server 202 may include a controller 204.

In various examples, the controller 204 may assign the virtual disk 210 to the client computing device 212. The controller 204 may configure the first and second disk arrays 206, 208 to have a specified RAID level. Configuring the first and second disk arrays 206, 208 may include assigning the first disk array 206 as a primary disk group of the virtual disk 210 and the second disk array 208 as a secondary disk group of the virtual disk 210. The controller 204 may be operable to detect a failure in one or more physical disks of the first disk array 206, and, in response to detecting the failure, assign the second disk array 208 to be the primary disk group.

The first disk array 206 may include a first subset of physical disks 206a, 206b, 206c, . . . 206n. The second disk array 208 may include a second subset of physical disks 208a, 208b, 208c, . . . 208n. The number of physical disks in the first disk array 206 and the second disk array 208 may be selected according to a RAID level selected by a user of the client computing device 212. In various examples, the RAID level may include RAID 0, RAID 1, RAID 5, RAID 6, RAID 1+0 RAID 5+0, and RAID 6+0, without limitation. The RAID 0 level may include two (2) physical disks in the primary disk group and two (2) physical disks in the secondary disk group. The RAID 1 level may include two (2) physical disks in the primary disk group and two (2) physical disks in the secondary disk group. The RAID 5 level may include three (3) physical disks in the primary disk group and three (3) physical disks in the secondary disk group. The RAID 6 level may include four (4) physical disks in the primary disk group and four (4) physical disks in the secondary disk group. The RAID 1+0 level may include four (4) physical disks in the primary disk group and four (4) physical disks in the secondary disk group. The RAID 5+0 level may include six (6) physical disks in the primary disk group and six (6) physical disks in the secondary disk group. The RAID 6+0 level may include eight (8) physical disks in the primary disk group and eight (8) physical disks in the secondary disk group. It would be appreciated by one of ordinary skill in the art that other RAID levels may be used and the number of physical disks in each RAID group may constitute a minimum number of disks needed for each RAID level.

In various examples, the virtual disk 210 may provide an interface between the client computing device 212 and the first and second disk arrays 206, 208. The client computing device 212 may send data to the virtual disk 210 over a communication network, such as the communication network 14 of FIG. 1. The virtual disk 210 may write the data to the first and second disk arrays 206, 208. In various examples, the virtual disk 210 may simultaneously or contemporaneously write the data to the first and second disk arrays 206, 208. The client computing device 212 may retrieve the data from or via the virtual disk 210 over the communication network.

In various examples, the controller 204 or the virtual disk 210 may detect a failure of one or more of the physical disks 206a, 206b, 206c, . . . 206n. In various examples, the controller 204 or the virtual disk 210 may detect a failure in each of the physical disks 206a, 206b, 206c, . . . 206n. In some examples, the virtual disk 210 may detect failure in one or more of the physical disks 206a, 206b, 206c, . . . 206n. Upon detecting the failure(s), the controller 204 or the virtual disk 210 may assign the second disk array 208 to be the primary disk group of the virtual disk 210. In various examples, either the controller 204 or the virtual disk 210 may assign the first and second disk arrays 206, 208 as the primary and secondary disk groups, detect a failure in the first disk array 206, and reassign the second disk array 208 to be the primary disk group.

After the second disk array 208 is assigned as the primary disk group, the client computing device 212 may continue to access the data through the virtual disk 210. The client computing device 212 may provide additional data to the virtual disk 210 over the communication network. The virtual disk 210 may write the additional data to the second disk array 208.

In various examples, after the second disk array 208 is assigned as the primary disk group, the first disk array 206 may be rebuilt. Rebuilding the first disk array 206 may include replacing or repairing one or more of the physical disks 206a, 206b, 206c, . . . 206n. After the one or more of the physical disks 206a, 206b, 206c, . . . 206n are replaced or repaired, the data from the client computing device 212, including the additional data, may be written to the first disk array 206. After the first disk array 206 is rebuilt, the controller 204 or virtual disk 210 may assign the first disk array to be the secondary disk group and the second disk array 208 may continue to be the primary disk group. If a failure is detected in the second disk array 208, the first disk array 206 may be assigned as the primary disk group. In various examples, no data may be lost due to a failure of each physical disk 206a, 206b, 206c, . . . 206n in the first disk array. For the RAID 1, RAID 5, RAID 6, RAID 1+0 RAID 5+0, and RAID 6+0 levels, no data may be lost due to failure in at least one of the physical disks 208a, 208b, 208c, . . . 208n in the secondary disk group, in addition to a failure of all physical disks 206a, 206b, 206c, . . . 206n in the primary disk group. Accordingly, the data storage system 201 may have a robust fault tolerance that can withstand catastrophic failure of an entire disk group without losing any data.

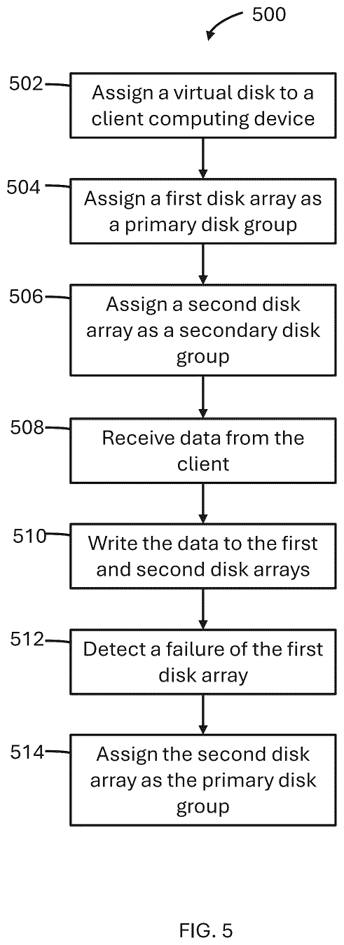

FIG. 5 illustrates an example computer-implemented method 500 for RAID group mirroring. In various examples, the method may be performed by a data storage system, such as the data storage system 16 of FIG. 1 or the data storage system 201 of FIG. 2. The data storage system may include a server, a controller, a plurality of physical disks, and a virtual disk, as described with reference to FIG. 2.

At operation 502, the controller may assign the virtual disk to a client computing device, such as the client computing device 12 of FIG. 1. The virtual disk may provide an interface between the client computing device and the physical disks of the storage system. The client computing device may access the virtual disk over a communication network, such as the communication network 14 of FIG. 1, to store data to and retrieve data from the data storage system. The server may perform a registration process with the client computing device to provide the client computing device with access to the virtual disk. The registration process may include a selection of a RAID configuration by the client computing device.

At operation 504, the controller may assign a first disk array of the plurality of physical disks as a primary disk group of the virtual disk. The first disk array may be a first subset of the physical disks. The first disk array may be configured by the controller or the virtual disk to have a RAID configuration. The RAID configuration may be selected by the client computing device. In various examples, the RAID configuration may include a RAID level.

At operation 506, the controller may assign a second disk array of the plurality of disks as a secondary disk group of the virtual disk. The second disk array may be a second subset of the plurality of physical disks. The second subset of physical disks may be different than the first subset of physical disks. The second disk array may include a same number of disks as the first disk array according to the selected RAID level. The controller or the virtual disk may configure the second disk array to have the same RAID configuration as the first disk array. Accordingly, the second disk array may be identical to or configured identically with the first disk array.

The number of physical disks in the first disk array and the second disk array may be selected according to the RAID level selected by or via the client computing device. In various examples, the RAID level may include RAID 0, RAID 1, RAID 5, RAID 6, RAID 1+0 RAID 5+0, and RAID 6+0, without limitation. The RAID levels may be as discussed in more detail above. It would be appreciated by one of ordinary skill in the art that other RAID levels may be used and the number of physical disks in each RAID group may constitute a minimum number of disks needed for each RAID level.

At operation 508, data may be received from the client computing device. The data may include client data to be stored in the first and second disk arrays. The data may be received by the virtual disk from the client computing device over the communication network.

At operation 510, the virtual disk may write the data to the first and second disk arrays. In various examples, the data may be simultaneously or contemporaneously written to the first and second disk arrays by the virtual disk. After the data has been written to both of the first and second disk arrays, the data storage system may send a notification to the client computing device indicating that the data has been written successfully.

At operation 512, a failure of the first disk array may be detected by the controller or the virtual disk. In various examples, the failure may be detected in at least one of the disks in the first disk array. In various examples, the failure may be detected in each of the disks in the first disk array. In various examples, no data may be lost due to a failure of each physical disk in the first disk array. For the RAID 1, RAID 5, RAID 6, RAID 1+0 RAID 5+0, and RAID 6+0 levels, no data may be lost due to failure in at least one of the physical disks in the secondary disk group, in addition to a failure of all physical disks in the primary disk group.

At operation 514, the controller or virtual disk may assign the second disk array as the primary disk group of the virtual disk based on the detected failure. The client computing device may continue to access the data stored in the second disk array. The client computing device may write additional data to the second disk array. Accordingly, the client computing device may have continuous access to the data in the event of a failure of the first disk group. In the event of a catastrophic failure of the first disk group, the data may be preserved in the second disk group and may be accessed by the client computing device.

Following assignment of the second disk array as the primary disk group, the data may be rebuilt in the first disk array. In various examples, rebuilding the first disk array may include replacing or repairing one or more faulty disks. In various examples, rebuilding the first disk array may include assigning a third subset of the physical disks to the first disk array of the virtual disk to replace the first subset of disks.

In various examples, the client computing device may send the data to rebuild the first disk array. Rebuilding the first disk array may include repair or replacement of faulty disks, restoration of the data that was previously stored in the first disk array, and addition of any data that has been written to the second disk array after failure of the first disk array. In various examples, the controller may copy the data from the second disk array to the first disk array. After rebuilding the first disk array, the controller or the virtual disk may assign the first disk array as the secondary disk group of the virtual disk. After assigning the first disk array as the secondary disk group, additional data received from the client computing device may be written to the first disk array and the second disk array. The additional data may be written to the first and second disk arrays simultaneously or contemporaneously. If a failure is detected in the second disk array, the first disk array may be assigned as the primary disk group. Accordingly, the data storage system may have a robust fault tolerance that can withstand catastrophic failure of an entire disk group without losing any data.

According to various examples of the present disclosure, a system may be provided. The system may include a client computing device and a data storage system. The data storage system may include a first disk array, a second disk array, a virtual disk, at least one processor, and a memory. The memory may store instructions that, when executed by the at least one processor, cause the at least one processor to perform the following operations: assign the virtual disk to the client computing device, assign the first disk array as a primary disk group of the virtual disk, assign the second disk array as a secondary disk group of the virtual disk, receive data from the client computing device, write the data to the first disk array and the second disk array, detect a failure of the first disk array, and based on the detected failure, assign the second disk array as the primary disk group.

In combination with any of the above examples, the first and second disk arrays may include a same number of disks.

In combination with any of the above examples, the data may be written to the first and second disk arrays simultaneously.

In combination with any of the above examples, the first disk array may include a plurality of disks. Detecting the failure may include detecting failure in at least one of the plurality of disks.

In combination with any of the above examples, detecting the failure may include detecting failure in each of the plurality of disks.

In combination with any of the above examples, the instructions, when executed by the at least one processor, may cause the at least one processor to rebuild the data in the first disk array following assignment of the second disk array as the primary disk group and assign the first disk array as the secondary disk group.

In combination with any of the above examples, assigning the first and second disk arrays may include configuring the first and second disk arrays to have a same RAID configuration.

According to various examples of the present disclosure, a computer implemented method is provided. A virtual disk may be assigned to a client computing device. A first disk array may be assigned as a primary disk group of the virtual disk. A second disk array may be assigned as a secondary disk group of the virtual disk. The virtual disk may receive data from the client computing device. The virtual disk may write the data to the first disk array and the second disk array. A failure of the first disk array may be detected. Based on the detected failure, the second disk array may be assigned as the primary disk group.

In combination with any of the above examples, the first and second disk arrays may include a same number of disks. The first and second disk arrays may be configured ID configuration.

In combination with any of the above examples, the data may be written to the first and second disk arrays simultaneously.

In combination with any of the above examples, the first disk array may include a plurality of disks. Detecting the failure may include detecting failure in at least one of the plurality of disks.

In combination with any of the above examples, detecting the failure may include detecting failure in each of the plurality of disks.

In combination with any of the above examples, the instructions, when executed by the at least one processor, may cause the at least one processor to rebuild the data in the first disk array following assignment of the second disk array as the primary disk group and assign the first disk array as the secondary disk group.

According to various examples of the present disclosure, non-transitory computer readable media may be provided. The non-transitory computer readable media may include instructions stored thereon that, when executed by at least one processor, cause the at least one processor to perform the following operations: receive data from a client computing device; write the data to a first disk array and a second disk array, said first and second disk arrays being managed by a virtual disk assigned to the client computing device, said first disk array being a primary disk group assigned to the client computing device, said second disk array being a secondary disk group assigned to the client computing device; detect a failure of the first disk array; and based on the detected failure, assign the second disk array as the primary disk group.

In combination with any of the above examples, the first and second disk arrays may include a same number of disks. The first and second disk arrays may be configured to have a same RAID configuration.

In combination with any of the above examples, the data may be written to the first and second disk arrays simultaneously.

In combination with any of the above examples, the first disk array may include a plurality of disks. Detecting the failure may include detecting failure in at least one of the plurality of disks.

In combination with any of the above examples, detecting the failure may include detecting failure in each of the plurality of disks.

In combination with any of the above examples, the method may include rebuilding the data in the first disk array following assignment of the second disk array as the primary disk group and assigning the first disk array as the secondary disk group.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A system comprising:
a client computing device; and
a data storage system including—
a first disk array;
a second disk array;
a virtual disk;
at least one processor; and
a memory having instructions stored thereon, that, when executed by the at least one processor, cause the at least one processor to:
assign the virtual disk to the client computing device,
assign the first disk array as a primary disk group of the virtual disk,
assign the second disk array as a secondary disk group of the virtual disk,
receive data from the client computing device,
write the data to the first disk array and the second disk array,
detect a failure of the first disk array,
based on the detected failure, assign the second disk array as the primary disk group.

2. The system of claim 1,
wherein the first and second disk arrays include a same number of disks.

3. The system of claim 1,
wherein the data is written to the first and second disk arrays simultaneously.

4. The system of claim 1,
wherein the first disk array includes a plurality of disks,
wherein detecting the failure includes detecting failure in at least one of the plurality of disks.

5. The system of claim 4,
wherein detecting the failure includes detecting failure in each of the plurality of disks.

6. The system of claim 1, wherein the instructions, when executed by the at least one processor, cause the at least one processor to—
following assignment of the second disk array as the primary disk group, rebuild the data in the first disk array,
assign the first disk array as the secondary disk group.

7. The system of claim 1,
wherein assigning the first and second disk arrays includes configuring the first and second disk arrays to have a same redundant array of independent disks (RAID) configuration.

8. A computer-implemented method comprising:
assigning a virtual disk to a client computing device;
assigning a first disk array as a primary disk group of the virtual disk;
assigning a second disk array as a secondary disk group of the virtual disk;
receiving data from the client computing device;
writing the data to the first disk array and the second disk array;
detecting a failure of the first disk array; and
based on the detected failure, assigning the second disk array as the primary disk group.

9. The computer-implemented method of claim 8,
wherein the first and second disk arrays include a same number of disks,
wherein assigning the first and second disk arrays includes configuring the first and second disk arrays to have a same redundant array of independent disks (RAID) configuration.

10. The computer-implemented method of claim 8,
wherein the data is written to the first and second disk arrays simultaneously.

11. The computer-implemented method of claim 8,
wherein the first disk array includes a plurality of disks,
wherein detecting the failure includes detecting failure in at least one of the plurality of disks.

12. The computer-implemented method of claim 11,
wherein detecting the failure includes detecting failure in each of the plurality of disks.

13. The computer-implemented method of claim 8, comprising
following assignment of the second disk array as the primary disk group, rebuilding the data in the first disk array,
assigning the first disk array as the secondary disk group.

14. Non-transitory computer readable media storing instructions, that when executed by at least one processor, cause the at least one processor to:
receive data from a client computing device;
write the data to a first disk array and a second disk array, said first and second disk arrays being managed by a virtual disk,
said virtual disk being assigned to the client computing device,
said first disk array being a primary disk group assigned to the client computing device,
said second disk array being a secondary disk group assigned to the client computing device;
detect a failure of the first disk array; and
based on the detected failure, assign the second disk array as the primary disk group.

15. The non-transitory computer readable media of claim 14,
wherein the first and second disk arrays include a same number of disks,
wherein the first and second disk arrays are configured to have a same redundant array of independent disks (RAID) configuration.

16. The non-transitory computer readable media of claim 14,
wherein the data is written to the first and second disk arrays simultaneously.

17. The non-transitory computer readable media of claim 14,
wherein the first disk array includes a plurality of disks,
wherein detecting the failure includes detecting failure in at least one of the plurality of disks.

18. The non-transitory computer readable media of claim 17,
wherein detecting the failure includes detecting failure in each of the plurality of disks.

19. The non-transitory computer readable media of claim 14, comprising
wherein the instructions, when executed by the at least one processor, cause the at least one processor to—
following assignment of the second disk array as the primary disk group, rebuild the data in the first disk array,
assign the first disk array as the secondary disk group.
